(19) United States
(12) Patent Application Publication
(10) Pub. No.: US 2018/0272368 A1
(43) Pub. Date: Sep. 27, 2018

(54) Sunscreen Application Assembly

(71) Applicant: Chris Drogitis, Belmont, CA (US)

(72) Inventor: Chris Drogitis, Belmont, CA (US)

(21) Appl. No.: 15/467,812

(22) Filed: Mar. 23, 2017

(51) Int. Cl. B05B 11/00; B65D 25/04; A45D 34/04

(52) U.S. Cl. CPC B05B 11/0078; A45D 34/04; B65D 25/04; B05B 11/3043

(57) ABSTRACT

A sunscreen application assembly includes a canister that has a plurality of chambers. Each of the chambers is fluidly discrete with respect to each other and each of the chambers contains a liquid. A pump unit is movably coupled to the canister and the pump unit is in fluid communication with the interior of the canister. The pump unit is selectively manipulated. The pump unit is selectively aligned with a selected one of the chambers to urge the liquid in the selected chamber outwardly therefrom.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to application devices and more particularly pertains to a new application device for containing and selectively dispensing a plurality of tanning products.

### BRIEF SUMMARY OF THE INVENTION

An embodiment of the disclosure meets the needs presented above by generally comprising a canister that has a plurality of chambers. Each of the chambers is fluidly discrete with respect to each other and each of the chambers contains a liquid. A pump unit is movably coupled to the canister and the pump unit is in fluid communication with the interior of the canister. The pump unit is selectively manipulated. The pump unit is selectively aligned with a selected one of the chambers to urge the liquid in the selected chamber outwardly therefrom.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a sunscreen application assembly according to an embodiment of the disclosure.

FIG. 2 is a right side view of an embodiment of the disclosure.

FIG. 3 is a top perspective in-use view of an embodiment of the disclosure.

FIG. 4 is a front view of an embodiment of the disclosure.

FIG. 5 is a cross sectional view taken along line 5-5 of FIG. 4 of an embodiment of the disclosure.

### DETAILED DESCRIPTION OF THE INVENTION

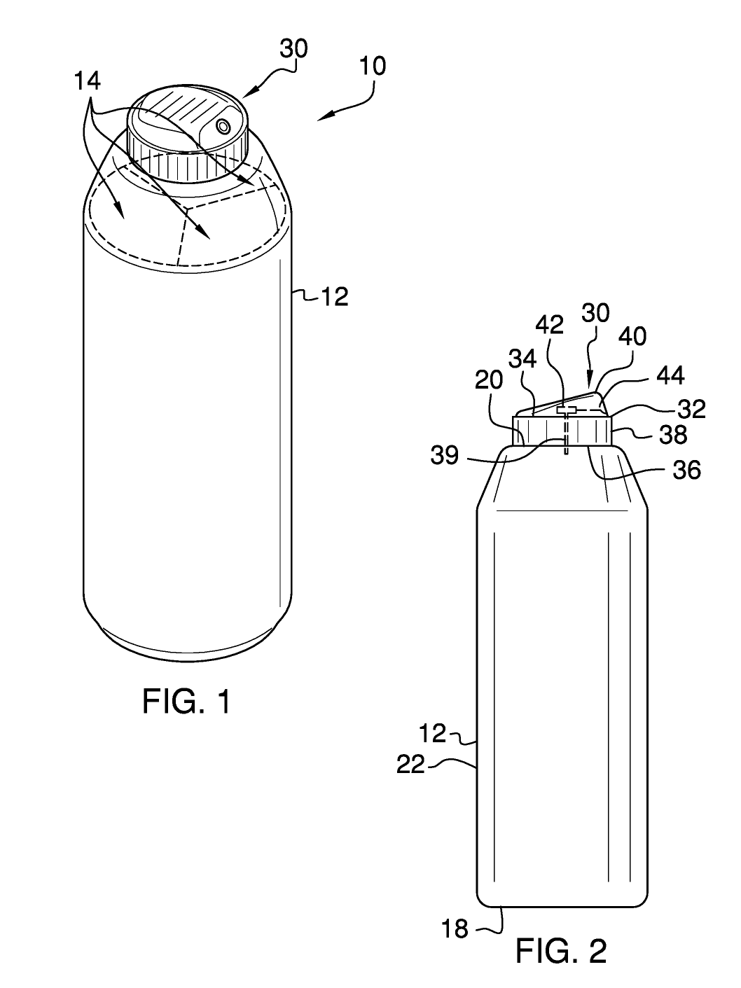

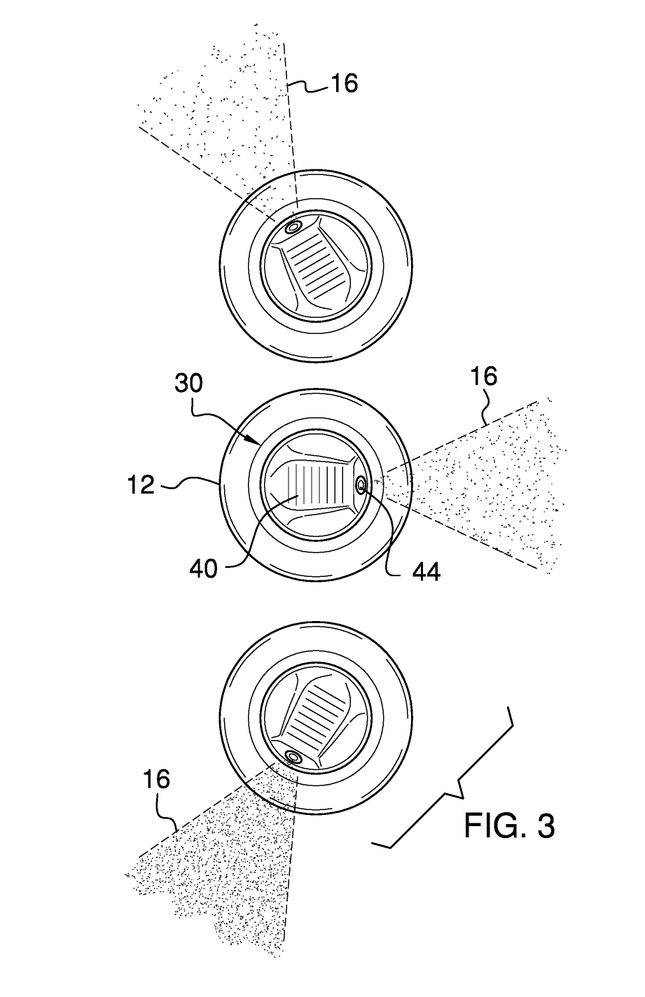

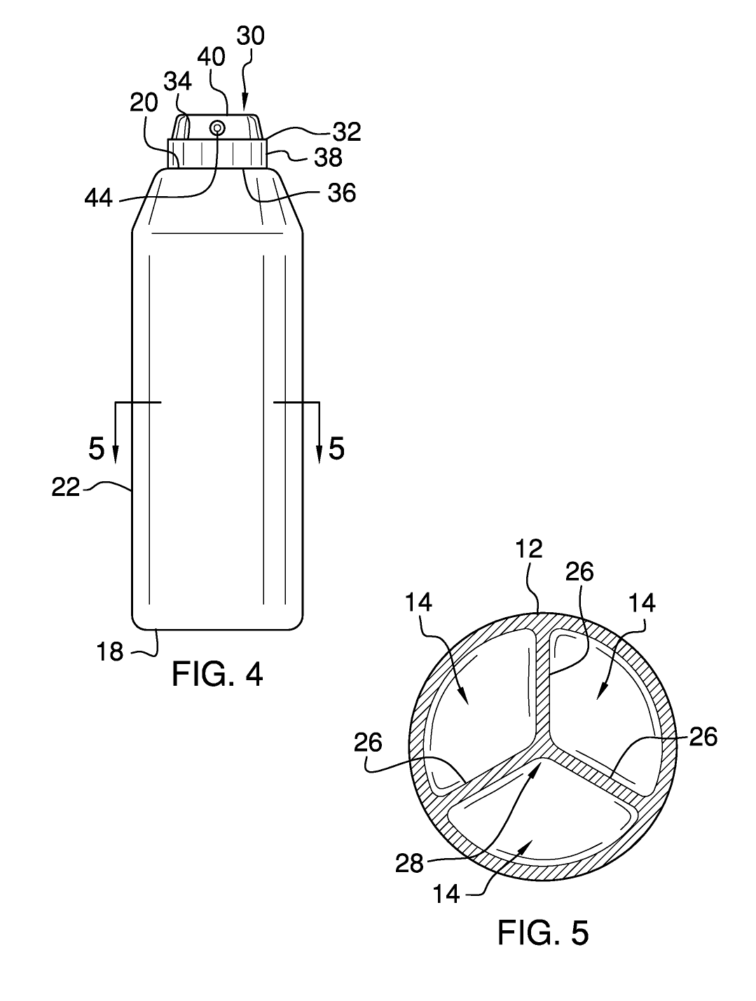

With reference now to the drawings, and in particular to FIGS. 1 through 5 thereof, a new application device embodying the principles and concepts of an embodiment of the disclosure and generally designated by the reference numeral 10 will be described.

As best illustrated in FIGS. 1 through 5, the sunscreen application assembly 10 generally comprises a canister 12 that has a plurality of chambers 14. Each of the chambers 14 is fluidly discrete with respect to each other and each of the chambers 14 contains a liquid 16. The liquid 16 in each of the chambers 14 may comprise a tanning product such as sunscreen, tanning oil or any other liquid tanning product. Additionally, the sunscreen may be sunscreen having a selected SPF rating. The canister 12 has a bottom wall 18, a top wall 20 and an outer wall 22 extending therebetween. The top wall 20 is open to access an interior of the canister 12 and the outer wall 22 has an inner surface 24.

A plurality of dividers 26 is provided and each of the dividers 26 is coupled to the inner surface 24 of the canister 12. The dividers 26 are spaced apart from each other and are distributed around the inner surface 24. Moreover, each of the dividers 26 intersects with each other at a center 28 of the canister 12 to define each of the chambers 14. Each of the dividers 26 extends between the bottom wall 18 and the top wall 20 of the canister 12.

A pump unit 30 is provided and the pump unit 30 is movably coupled to the canister 12. Moreover, the pump unit 30 is in fluid communication with the interior of the canister 12. The pump unit 30 is selectively manipulated to be selectively aligned with a selected one of the chambers 14. In this way the pump unit 30 selectively urges the liquid 16 in the selected chamber outwardly therefrom.

The pump unit 30 comprises a disk 32 that has an upper side 34, a lower side 36 and a peripheral edge 38 extending therebetween. The lower side 36 is rotatably coupled to the top wall 20 of the canister 12 and the disk 32 closes the top wall 20 of the canister 12. The peripheral edge 38 is selectively manipulated thereby facilitating the disk 32 to be rotated on the canister 12. A conduit 39 extends through the upper side 34 and the lower side 36. Moreover, the conduit 39 is placed in fluid communication with a selected one of the chambers 14 when the disk 32 is rotated.

A pump 40 is coupled to the upper side 34 of the disk 32 and the pump 40 is selectively manipulated. The pump 40 has an input 42 and an output 44; the input 42 is fluidly coupled to the conduit 39. In this way the pump 40 is in fluid communication with the selected chamber 14. The output 44 extends outwardly form the pump 40 to spray the liquid 16 in the selected chamber 14 when the pump 40 is manipulated. The pump 40 may be a push button pump or any other type of mechanical fluid pump and the output 44 may be a spray nozzle.

In use, the peripheral edge 38 of the disk 32 is gripped to align the conduit 39 with a selected one of the chambers 14. The pump 40 is manipulated to spray the liquid 16 in the selected chamber outwardly through the output 44 on the pump 40. In this way the liquid 16 in the selected chamber 14 is sprayed onto a user for tanning purposes. The canister 12 facilitates the plurality of tanning products to be contained in a single container thereby enhancing efficiency with respect to transporting and dispensing the tanning products.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A sunscreen application assembly being configured to contain and selectively dispense a plurality of tanning products, said assembly comprising:
a canister having a plurality of chambers, each of said chambers being fluidly discrete with respect to each other, each of said chambers being configured to contain a liquid, said canister having a top end, said top end being open; and
a pump unit being movably coupled to said canister such that said pump unit is in fluid communication with said interior of said canister, said pump unit being configured to be manipulated, said pump unit being selectively aligned with a selected one of said chambers wherein said pump unit is configured to urge the liquid in said selected chamber outwardly therefrom, said pump unit comprising a disk having an upper side, a lower side and a peripheral edge extending therebetween, said lower side being rotatably coupled to said top wall of said canister such that said disk closes said top wall of said canister, said peripheral edge being configured to be manipulated thereby facilitating said disk to be rotated on said canister, said pump unit further including a conduit extending through said upper side and said lower side, said conduit being placed in fluid communication with a selected one of said chambers when said disk is rotated, said pump unit including a pump being coupled to said upper side of said disk wherein said pump is configured to be manipulated by a motion directly towards said upper side of said disk, said pump having an input and an output, said input being fluidly coupled to said conduit such that said pump is in fluid communication with said selected chamber, said output extending outwardly form said pump wherein said output is configured to spray the fluid in said selected chamber when said pump is manipulated.

2. The assembly according to claim 1, further comprising:
said canister having a bottom wall, a top wall and an outer wall extending therebetween, said top wall being open to access an interior of said canister, said outer wall having an inner surface; and
a plurality of dividers, each of said dividers being coupled to said inner surface of said canister, said dividers being spaced apart from each other and being distributed around said inner surface, each of said dividers extending between said bottom wall and said top wall.

3. (canceled)

4. (canceled)

5. (canceled)

6. A sunscreen application assembly being configured to contain and selectively dispense a plurality of tanning products, said assembly comprising:
a canister having a plurality of chambers, each of said chambers being fluidly discrete with respect to each other, each of said chambers being configured to contain a liquid, said canister having a bottom wall, a top wall and an outer wall extending therebetween, said top wall being open to access an interior of said canister, said outer wall having an inner surface;
a plurality of dividers, each of said dividers being coupled to said inner surface of said canister, said dividers being spaced apart from each other and being distributed around said inner surface, each of said dividers intersecting with each other at a center of said canister to define each of said chambers, each of said dividers extending between said bottom wall and said top wall; and
a pump unit being movably coupled to said canister such that said pump unit is in fluid communication with said interior of said canister, said pump unit being configured to be manipulated, said pump unit being selectively aligned with a selected one of said chambers wherein said pump unit is configured to urge the liquid in said selected chamber outwardly therefrom, said pump unit comprising:
a disk having an upper side, a lower side and a peripheral edge extending therebetween, said lower side being rotatably coupled to said top wall of said canister such that said disk closes said top wall of said canister, said peripheral edge being configured to be manipulated thereby facilitating said disk to be rotated on said canister,
a conduit extending through said upper side and said lower side, said conduit being placed in fluid communication with a selected one of said chambers when said disk is rotated, and
a pump being coupled to said upper side of said disk wherein said pump is configured to be manipulated by a motion directly towards said upper side of said disk, said pump having an input and an output, said input being fluidly coupled to said conduit such that said pump is in fluid communication with said selected chamber, said output extending outwardly form said pump wherein said output is configured to spray the fluid in said selected chamber when said pump is manipulated.
